(19) United States
(12) Patent Application Publication
(10) Pub. No.: US 2012/0154545 A1
(43) Pub. Date: Jun. 21, 2012

(54) IMAGE PROCESSING APPARATUS AND METHOD FOR HUMAN COMPUTER INTERACTION

(75) Inventors: Seung-Min Choi, Daejeon (KR); Ji-Ho Chang, Gyeonggi-do (KR); Jae-Il Cho, Daejeon (KR); Dae-Hwan Hwang, Daejeon (KR); Ho-Chul Shin, Daejeon (KR)

(73) Assignee: Electronics and Telecommunications Research Institute, Daejeon-city (KR)

(21) Appl. No.: 13/326,799

(22) Filed: Dec. 15, 2011

(30) Foreign Application Priority Data
Dec. 21, 2010 (KR) 10-2010-0131556

(51) Int. Cl. H04N 13/02

(52) U.S. Cl. 348/47; 348/E13.074

(57) ABSTRACT

Disclosed herein is an image processing apparatus for human computer interaction. The image processing apparatus includes an image processing combination unit and a combined image provision unit. The image processing combination unit generates information processed before combination using right and left input images captured by respective right and left stereo cameras. The combined image provision unit provides a combined output image combined into a single image by selecting only information desired by a user among the information processed before combination.

### CROSS REFERENCE TO RELATED APPLICATION

This application claims the benefit of Korean Patent Application No. 10-2010-0131556, filed on Dec. 21, 2010, which is hereby incorporated by reference in its entirety into this application.

### BACKGROUND OF THE INVENTION

1. Technical Field

The present invention relates generally to an image processing apparatus and method for human computer interaction, and, more particularly, to an image processing apparatus and method which combines image processing technologies necessary for Human Computer Interaction (HCI) in a single apparatus.

2. Description of the Related Art

Using stereoscopic image information, the face and the color of flesh are the most useful methods of recognizing a user without using artificial markers in image processing technologies. However, since a large amount of operations are required to obtain excellent results in most of the image processing technologies, the development of commercial products for processing images in real time using only software has limitations.

For this reason, face detection and stereo matching which require complex operations were developed as elements separate from other key components used in the image processing technologies. However, when these elements are used, perfect results cannot be obtained due to camera noise, variations in the light, low resolution, the use of effective resources, and the characteristics of algorithms. Therefore, there is a problem of combining results which are output from respective elements and which have a low recognition rate, and then using the combined results.

### SUMMARY OF THE INVENTION

Accordingly, the present invention has been made keeping in mind the above problems occurring in the prior art, and an object of the present invention is to provide an image processing apparatus and method which can combine essential image processing technologies used for Human Computer Interaction (HCI) in a single element, and which can process the image processing technologies.

In order to accomplish the above object, the present invention provides an image processing apparatus for human computer interaction, including: an image processing combination unit for generating information processed before combination using right and left input images captured by respective right and left stereo cameras; and a combined image provision unit for providing a combined output image which is combined into a single image by selecting only information desired by a user among the information processed before combination.

The information processed before combination may include the boundary lines of each of the right and left input images, the density of the boundary lines, a facial coordinate region, the skin color of a face, disparity between the right and left input images, and a difference image for each of the right and left input images.

The image processing combination unit may include a filtering processing unit for removing noise while maintaining the boundary lines for each of the right and left input images in current frame, and providing a previous frame generated immediately before the current frame.

The image processing combination unit may include a boundary line processing unit for displaying the boundary lines for each of the right and left input images using the noise-removed right and left input images, and expressing the density of the boundary lines numerically.

The image processing combination unit may include a facial region detection unit for detecting and outputting the facial coordinate region using the noise-removed right and left input images.

The image processing combination unit may include a skin color processing unit for detecting the skin color of the facial coordinate region by applying a skin color filter to the facial coordinate region.

The image processing combination unit may include a stereoscopic image disparity processing unit for calculating disparity for the noise-removed right and left input images.

The image processing combination unit may include a motion detection unit for outputting the difference image based on results of comparison the previous frame and each of the noise-removed right and left input images respectively.

The motion detection unit may calculate a difference value of intensity in units of a pixel between each of the noise-removed right and left input images in current and the previous frame, and determining movement by outputting the difference image corresponding to the difference value.

The combined image provision unit may divides a region displayed displayed the combined output image based on information desired by a user, and then provides the combined output image to the user by outputting the combined output image on regions according to a Picture-in-Picture (PIP) method.

In order to accomplish the above object, the present invention provides an image processing method for human computer interaction, including: receiving right and left input images captured by respective right and left stereo cameras; generating information processed before combination using the right and left input images; selecting information only desired by a user among the information processed before combination; and providing a combined output image by combining the information desired by the user into a single image.

The receiving the right and left input images may include removing noise while maintaining the boundary lines for each of the right and left input images in current frame.

The generating the information processed before combination may include: displaying the boundary lines for each of the right and left input images using the noise-removed right and left input images; and expressing the density of the boundary lines numerically.

The generating the information processed before combination may include: detecting and outputting a facial coordinate region using the noise-removed right and left input images; and detecting the skin color of the facial coordinate region by applying a skin color filter to the facial coordinate region.

The generating the information processed before combination may include calculating disparity for the noise-removed right and left input images.

The generating the information processed before combination may include: calculating a difference value of intensities in units of a pixel between a previous frame immediately before the current frame and each of the noise-removed right and left input images; and determining movement by outputting the difference image based on result of comparison the difference value and a threshold.

The providing the combined output image may include: dividing a region displayed the combined output image based on the information desired by the user; and providing the combined output image to the user by outputting the combined output image on regions according to a Picture-in-Picture (PIP) method.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram schematically illustrating an image processing apparatus used for human computer interaction according to an embodiment of the present invention;

FIG. 2 is a block diagram schematically illustrating the image processing combination unit of the image processing apparatus of FIG. 1;

FIG. 3 is a block diagram schematically illustrating a right and left image reception unit of FIG. 2;

FIGS. 4 and 5 are views illustrating examples in which facial coordinates are output according to an embodiment of the present invention;

FIG. 6 is a view illustrating an example in which the image processing apparatus of FIG. 1 provides a combined output image to regions, obtained through division, according to a PIP method; and

FIG. 7 is a flowchart illustrating the order in which the image processing apparatus of FIG. 1 provides the combined output image.

### DESCRIPTION OF THE PREFERRED EMBODIMENTS

The present invention will be described in detail with reference to the accompanying drawings below. Here, when the description is repetitive and detailed descriptions of well-known functions or configurations would unnecessarily obscure the gist of the present invention, the detailed descriptions will be omitted. The embodiments of the present invention are provided to complete the explanation for those skilled in the art the present invention. Therefore, the shapes and sizes of components in the drawings may be exaggerated to provide a more exact description.

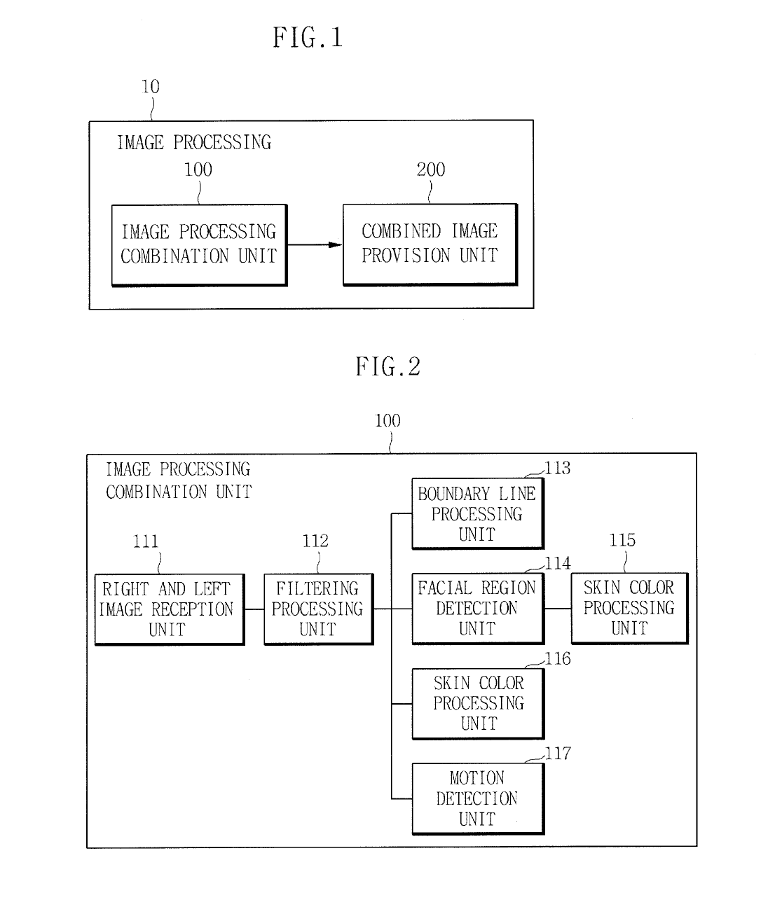

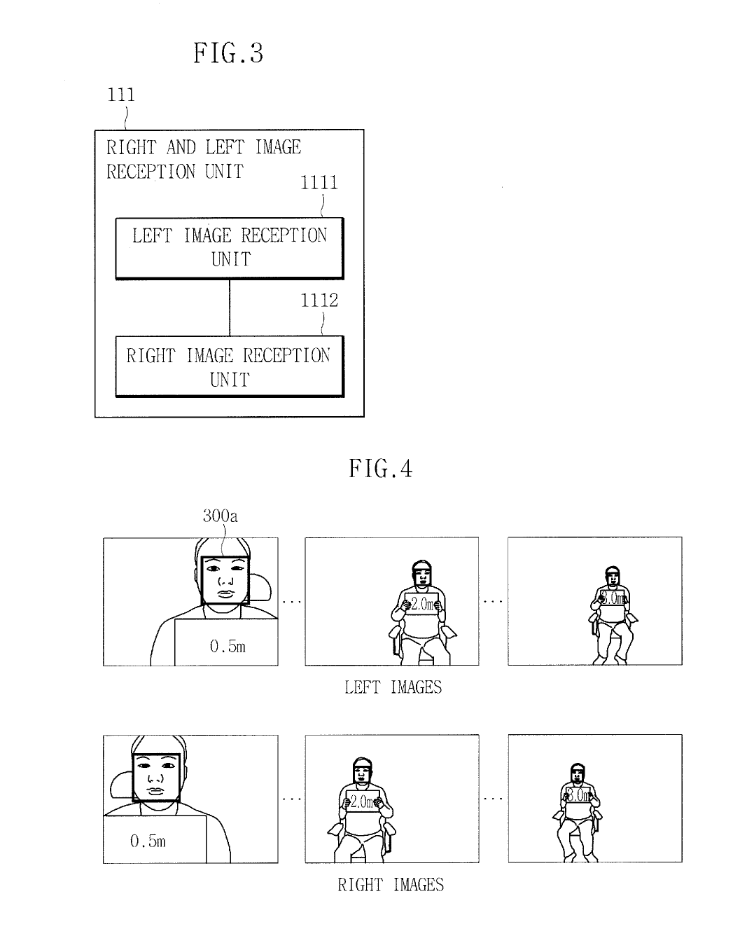

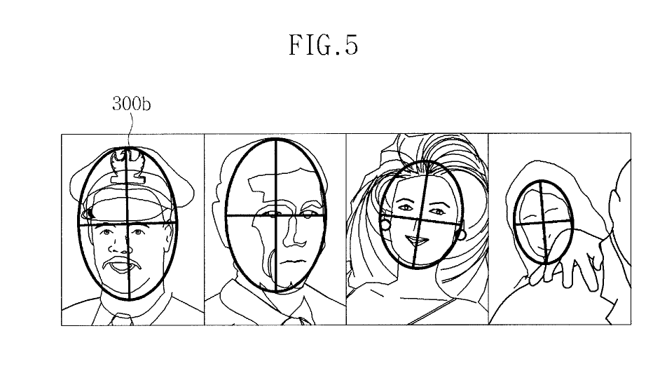

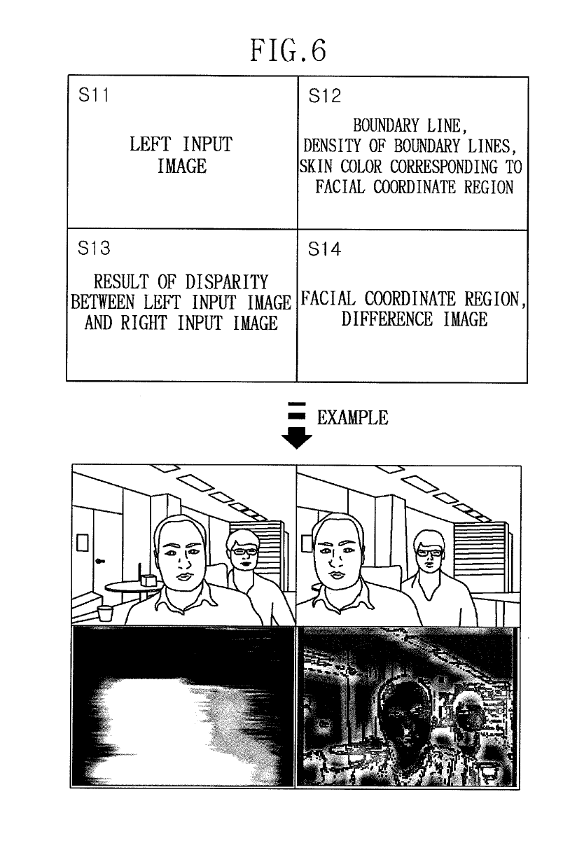

FIG. 1 is a block diagram schematically illustrating an image processing apparatus used for human computer interaction according to an embodiment of the present invention. FIG. 2 is a block diagram schematically illustrating the image processing combination unit of the image processing apparatus of FIG. 1. FIG. 3 is a block diagram schematically illustrating a right and left image reception unit of FIG. 2. FIGS. 4 and 5 are views illustrating examples in which facial coordinates are output according to an embodiment of the present invention. FIG. 6 is a view illustrating an example in which the image processing apparatus of FIG. 1 provides a combined output image to regions, obtained through division, according to a Picture-in-Picture (PIP) method.

As shown in FIG. 1, an image processing apparatus 10 used for human computer interaction according to an embodiment of the present invention is a single element that integrates essential technologies used for image processing, and includes an image processing combination unit 100 and a combined image provision unit 200.

As shown in FIG. 2, the image processing combination unit 100 includes a right and left image reception unit 111, a filtering processing unit 112, a boundary line processing unit 113, a facial region detection unit 114, a skin color processing unit 115, a stereoscopic image disparity processing unit 116, and a motion detection unit 117.

The right and left image reception unit 111 receives input images captured by respective right and left stereo cameras (not shown), and includes a left image reception unit 1111 for receiving a left input image captured by a left stereo camera, and a right image reception unit 1112 for receiving a right input image captured by a right stereo camera, as shown in FIG. 3.

Referring to FIG. 2 again, the filtering processing unit 112 receives input images (hereinafter referred to as “right and left input images”) from the right and left image reception unit 111. The filtering processing unit 112 removes the noise of the images while maintaining the boundary lines of the right and left input images. The filtering processing unit 112 transmits the right and left input images, from which noise was removed, to each of the boundary line processing unit 113, the facial region detection unit 114, the stereoscopic image disparity processing unit 116 and the motion detection unit 117.

The boundary line processing unit 113 receives the right and left input images, from which noise was removed, from the filtering processing unit 112, and displays the existence/nonexistence of boundary lines. Further, the boundary line processing unit 113 expresses the density of the boundary lines in the right and left input images on which the existence and nonexistence of boundary lines is displayed.

In particular, the boundary line processing unit 113 receives the right and left input images, displays an area in which one or more boundary lines exist using a white color (255), and displays an area in which a boundary line does not exist using a black color (0). When boundary lines are displayed as described above, a difference is created in the density of the boundary lines by using a plurality of overlapping white lines appearing in an area in which there are a large number of small boundaries, and using the black color in other areas. When the detection results of the boundary lines are accumulated using windows having a specific size, the density of the boundary lines is displayed in such a way that an area where there is a large number of boundary lines is displayed as a high value, and an area where there is a small number of boundary lines is displayed as a low value.

For example, if it is assumed that the density of the boundary lines of a current pixel is calculated using a 10×10 sized block window, the boundary line processing unit 113 performs normalization in such a way as to add all the boundary lines in the 10×10 window using the current pixel as the center. Thereafter, the boundary line processing unit 113 expresses the density of the boundary lines numerically using the detection results of the accumulated boundary lines.

The facial region detection unit 114 receives the right and left input images, from which noise was removed, from the filtering processing unit 112, and detects and outputs a facial coordinate region. For example, the facial region detection unit 114 outputs the facial coordinate region by forming a rectangular box 300a or an ellipse 300b on the facial region. Examples of the facial coordinate region are shown in FIGS. 4 and. 5. The facial region detection unit 114 transmits the facial coordinate region to the skin color processing unit 115.

The skin color processing unit 115 analyzes information about the skin color of the facial coordinate region detected from the right and left input images. Thereafter, the skin color processing unit 115 calculates skin color parameters corresponding to the information about the skin color of the facial coordinate region. Here, the skin color parameters are defined based on a color space used in the images, and may be set using experimental values obtained by performing experiments that provide knowledge about the statistical distribution of skin colors using a previous computational operation, or may be set using representative constants.

For example, the current r, g, and b values of each of input pixels are formed of 8 bits (0 to 255), so that the skin color parameters are calculated and displayed in the form of min_r, min_g, min_b, max_r, max_g, and max_b. The relationship between a pixel and the skin color parameters is expressed by the following Equation 1:

Min_{—}r<r<max_{—}r

Min_{—}g<g<max_{—}g

Min_{—}b<b<max_{—}b (1)

Further, the skin color processing unit 115 detects the skin color of a facial region in such a way as to pass only the skin color Region of Interest (ROI) of the facial coordinate region, which falls into a parameter section using a skin color filter. That is, one or more pixels which satisfy the conditions of Equation 1 are determined to have been pixels that passed through the skin color filter, and pixels which did not pass through the skin color filter are determined not to be skin color. In the embodiment of the present invention, RGB (Red, Green, and Blue) are used for a pixel. However, the present invention is not limited thereto and the YUV422 color space may be used.

The stereoscopic image disparity processing unit 116 receives right and left input images, from which noise was removed, from the filtering processing unit 112. The stereoscopic image disparity processing unit 116 calculates the disparity of right and left input images based on the right and left input images.

The motion detection unit 117 receives an (n−1)-th frame, which is previous to a current n-th frame, and a left input image, in which noise is removed from the current n-th frame, from the filtering processing unit 112. The motion detection unit 117 calculates the difference in intensities in units of a pixel between the (n−1)-th frame of the left input image and the left input image in which noise was removed from the n-th frame. When the difference in intensities is greater than a threshold, the motion detection unit 117 outputs a corresponding pixel value as “1”. When the difference in intensities is lower than a threshold, the motion detection unit 117 outputs the corresponding pixel value as “0”. Therefore, the motion detection unit 117 outputs the difference image of the left input image. That is, the motion detection unit 117 determines that movement occurred when the corresponding pixel value is “1”, and determines that movement does not occur when the corresponding pixel value is “0”.

In the same manner, the motion detection unit 117 calculates the difference in intensities in the units of a pixel between the (n−1)-th frame of the right input image and the right input image in which noise was removed from the current n-th frame. When the difference in intensities is greater than a threshold, the motion detection unit 117 outputs a corresponding pixel value as “1”. When the difference in intensities is lower than a threshold, the motion detection unit 117 outputs the corresponding pixel value as “0”. Therefore, the motion detection unit 117 outputs the difference image of the right input image.

Referring to FIG. 1 again, the combined image provision unit 200 receives information processed before combination, that is, information about the right and left input images that were processed by the units 111 to 117 of the image processing combination unit 100 in order to select only the information desired by a user, combine the selected information in a single image, and then provide the single image. The combined image provision unit 200 selects only image information desired by the user from among information processed before the combination for all of the images received from the image processing combination unit 100, and then provides a combined output image in which the pieces of desired image information are combined together into a single image according to PIP method. That is, the combined image provision unit 200 performs division on a region, in which an image will be displayed such that the combined output image can be displayed, based on the information desired by the user, and outputs the combined output image to regions obtained through the division according to the PIP method, thereby providing the combined output image to the user.

For example, as shown in FIG. 6, it is assumed that an input image which is input to the image processing combination unit 100 is an N×M image, that an output image which is provided from the combined image provision unit 200 is an (N×2)×(M×2) image, and that a Y(brightness)CbCr(chrominance) 4:2:2 format is used. The combined image provision unit 200 divides a region, in which a combined output image is displayed, into four sections S11 to S14, and displays only image information desired by the user in the four sections.

That is, the combined image provision unit 200 displays a left input image, which was captured by the left stereo camera and which will be processed by the image processing combination unit 100, on a first region S11. The combined image provision unit 200 displays a right input image, which was captured by the right stereo camera and which will be processed by the image processing combination unit 100, on a second region S12. Further, the combined image provision unit 200 codes disparity (for example, 8 bits) between the left input image and the right input image, which was output as a result by the stereoscopic image disparity processing unit 116, only for a brightness bit Y, and then displays the coding result on a third region S13. The combined image provision unit 200 codes the number of detected faces, the sizes of the detected faces, and the coordinate values of the detected faces for the brightness bit value Y of a first line using the facial region detection unit 114, and then codes the results of the difference image for the location of bit 0 of the brightness bit value Y from a second line to the last line using the motion detection unit 117, and then displays the coding result on a fourth region S14.

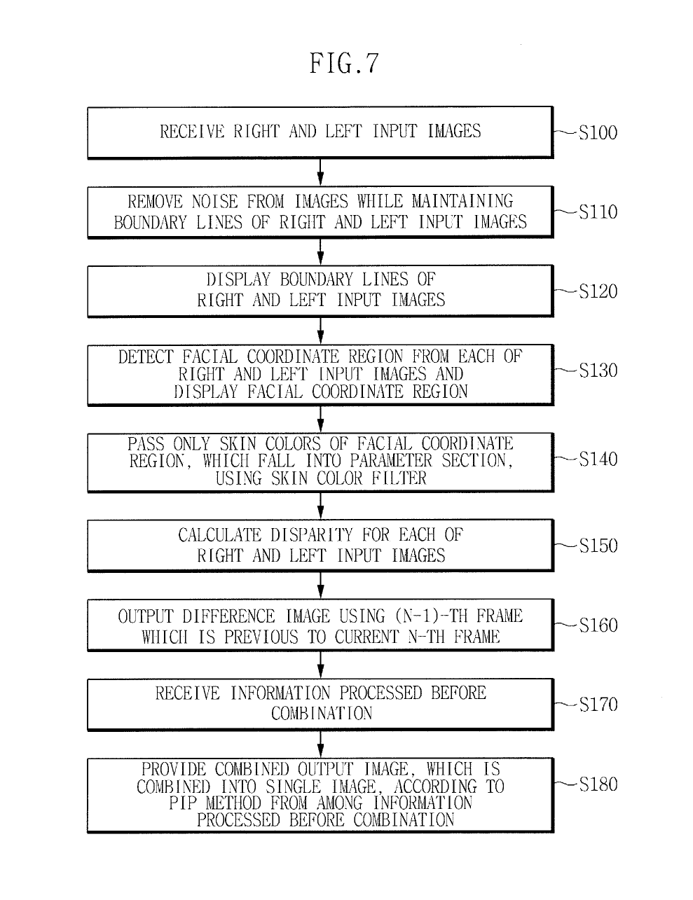

FIG. 7 is a flowchart illustrating the order in which the image processing apparatus of FIG. 1 provides the combined output image.

As shown in FIG. 7, the right and left image reception unit 111 of the image processing combination unit 100 according to the embodiment of the present invention receives right and left input images which were taken by the right and left stereo cameras, respectively, at step S100.

The filtering processing unit 112 removes noise from the images while maintaining the boundary lines of the right and left input images, and then provides the resulting images to the boundary line processing unit 113, the facial region detection unit 114, the stereoscopic image disparity processing unit 116, and the motion detection unit 117 at step S110.

The boundary line processing unit 113 receives the right and left input images from the filtering processing unit 112, and then displays the existence and non-existence of the boundary lines at step S120.

The facial region detection unit 114 receives the right and left input images from the filtering processing unit 112, and detects and outputs a facial coordinate region. The facial region detection unit 114 transmits the facial coordinate region to the skin color processing unit 115 at step S130. Thereafter, the skin color processing unit 115 calculates the parameters of the facial coordinate region and passes only the skin colors of the facial coordinate region, which fall into a parameter section, using the skin color filter at step S140.

The stereoscopic image disparity processing unit 116 receives the right and left input images from the filtering processing unit 112, and calculates the disparity for each of the right and left input images at step S150.

The motion detection unit 117 receives a (n−1)-th frame, which is previous to the current n-th frame, from the filtering processing unit 112, and outputs a difference image, thereby displaying whether movement occurred at step S160.

Thereafter, the combined image provision unit 200 receives information processed before combination for the right and left input images processed by each of the units 111 to 117 of the image processing combination unit 100. The combined image provision unit 200 selects only image information desired by the user from among the information processed before the combination, and provides a combined output image which is combined to a single image according to the PIP method at steps S170 and S180.

As described above, in the image processing apparatus 10 according to the embodiment of the present invention, noise is removed from right and left input images while maintaining the boundary lines of the right and left input images, the skin colors of a face are filtered by passing only skin colors corresponding to the facial coordinate region, the disparity between right and left images is calculated, and a combined output image is provided in such a way as to combine information processed before combination, the information including a difference image which was output using a previous frame and a current frame, according to the PIP method, so that technologies which are essential to image processing may be combined into a single element and then provided, thereby selectively providing only image information desired by a user.

According to the embodiment of the present invention, the image processing apparatus for human computer interaction removes noise from images while maintaining the boundary lines of right and left input images, performs filtering on the skin color of a face by passing only skin colors corresponding to a facial coordinate region, calculates the disparity between right and left images, and provides a combined output image in such a way as to combine information processed before combination, which includes a difference image output using the difference between a previous frame and a current frame according to the PIP method, so that technologies which are essential to image processing may be combined into a single element and then provided, thereby selectively combining only the image information desired by a user and then providing the combined information.

Further, according to the embodiment of the present invention, technologies which are essential to image processing are combined and provided by a single image processing apparatus, so that various HCI application technologies may be developed in an embedded system which has low specifications, thereby effectively reducing the cost of manufacturing a Television (TV), a mobile device, and a robot.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An image processing apparatus for human computer interaction, comprising:
an image processing combination unit for generating information processed before combination using right and left input images captured by respective right and left stereo cameras; and
a combined image provision unit for providing a combined output image combined into a single image by selecting only information desired by a user among the information processed before combination.

2. The image processing apparatus as set forth in claim 1, wherein the information processed before combination comprises boundary lines of each of the right and left input images, density of the boundary lines, a facial coordinate region, a skin color of a face, disparity between the right and left input images, and a difference image for each of the right and left input images.

3. The image processing apparatus as set forth in claim 2, wherein the image processing combination unit comprises a filtering processing unit for removing noise while maintaining the boundary lines for each of the right and left input images in current frame, and providing a previous frame generated immediately before the current frame.

4. The image processing apparatus as set forth in claim 3, wherein the image processing combination unit comprises a boundary line processing unit for displaying the boundary lines for each of the right and left input images using the right and left input images removed noise, and expressing the density of the boundary lines numerically.

5. The image processing apparatus as set forth in claim 3, wherein the image processing combination unit comprises a facial region detection unit for detecting and outputting the facial coordinate region using the noise-removed right and left input images.

6. The image processing apparatus as set forth in claim 5, wherein the image processing combination unit comprises a skin color processing unit for detecting a skin color of the facial coordinate region by applying a skin color filter to the facial coordinate region.

7. The image processing apparatus as set forth in claim 3, wherein the image processing combination unit comprises a stereoscopic image disparity processing unit for calculating disparity for the noise-removed right and left input images.

8. The image processing apparatus as set forth in claim 3, wherein the image processing combination unit comprises a motion detection unit for outputting the difference image based on results of comparison the previous frame and each of the noise-removed right and left input images, respectively.

9. The image processing apparatus as set forth in claim 3, wherein the motion detection unit calculating a difference value of intensity in units of a pixel between each of the noise-removed right and left input images in current and the previous frame, and determining movement by outputting the difference image corresponding to the difference value.

10. The image processing apparatus as set forth in claim 1, wherein the combined image provision unit divides a region displayed the combined output image based on information desired by a user, and then provides the combined output image to the user by outputting the combined output image on regions according to a Picture-in-Picture (PIP) method.

11. An image processing method for human computer interaction, comprising:
receiving right and left input images captured by respective right and left stereo cameras;
generating information processed before combination using the right and left input images;
selecting information only desired by a user among the information processed before combination; and
providing a combined output image by combining the information desired by the user into a single image.

12. The image processing method as set forth in claim 11, wherein the receiving the right and left input images comprises removing noise while maintaining boundary lines for each of the right and left input images in current frame.

13. The image processing method as set forth in claim 12, wherein the generating the information processed before combination comprises:
displaying the boundary lines for each of the right and left input images using the noise-removed right and left input images; and
expressing a density of the boundary lines numerically.

14. The image processing method as set forth in claim 12, wherein the generating the information processed before combination comprises:
detecting and outputting a facial coordinate region using the noise-removed right and left input images; and
detecting a skin color of the facial coordinate region by applying a skin color filter to the facial coordinate region.

15. The image processing method as set forth in claim 12, wherein the generating the information processed before combination comprises calculating disparity for the noise-removed right and left input images.

16. The image processing method as set forth in claim 12, wherein the generating the information processed before combination comprises:
calculating a difference value of intensities in units of a pixel between a previous frame immediately before the current frame and each of the noise-removed right and left input images; and
determining movement by outputting the difference image based on result of comparison the difference value and a threshold.

17. The image processing method as set forth in claim 11, wherein the providing the combined output image comprises:
dividing a region displayed the combined output image based on the information desired by the user; and
providing the combined output image to the user by outputting the combined output image on regions according to a Picture-in-Picture (PIP) method.
